(19) United States
(12) Patent Application Publication
(10) Pub. No.: US 2003/0125093 A1
(43) Pub. Date: Jul. 3, 2003

(54) Portable terminal unit

(75) Inventor: Tomoaki One, Hitachi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/301,179

(22) Filed: Nov. 20, 2002

(30) Foreign Application Priority Data
Nov. 20, 2001 (JP) 2001-354972

(51) Int. Cl. H04B 1/38

(52) U.S. Cl. 455/566; 455/550

(57) ABSTRACT

An attempt is made to be able to know the contents of usable information stored in a memory unit by simple operation. For example, when information about a schedule which is one of the usable information is selected on a high-level menu screen, a schedule menu screen which lists a schedule menu is displayed and a focus is displayed on this screen. If the focus is adjusted to a desired menu and a predetermined setting time elapses without performing anything sequentially, processing automatically enters a display state of a schedule outline screen for the menu specified with the focus. On this schedule outline screen, a dual window opens and summary information which indicates rough contents of this specified menu is displayed there.

### BACKGROUND OF THE INVENTION

1. Field of the Invention

The present invention relates to a portable terminal unit, and, more particularly, to a portable terminal unit which can store usable information of every kind and display this information by reading it as occasion demands.

2. Description of the Prior Art

A cellular phone which is a portable terminal unit can store information necessary for an owner (hereafter referred to as a user) of this cellular phone as well as enables a call and mail and can also display this information by reading it as occasion demands. As such information, there are information, for example, a telephone directory, a user schedule, and a task list (a program such as a job) (such information is hereinafter referred to as usable information). These usable information of all kinds are entered by allowing the user to operate a key for an input unit of the cellular phone and can be read by such an operation (such an operation is hereinafter referred to as key-entry).

The entered usable information of every kind is hierarchically constructed and stored to facilitate its fetch from the memory unit. Accordingly, to fetch necessary usable information from such usable information, a usable information menu screen consisting of a menu list every usable information of all kinds is displayed by the key-entry of the input unit. When a desired usable information menu (for example, a schedule menu) is selected and operated on this usable information menu screen, a screen which shows detailed contents of this usable information is displayed. If selection items are further provided on such a screen according to a hierarchical structure of the usable information, when any of the selection items is selected, more detailed contents of the selection item are displayed.

### SUMMARY OF THE INVENTION

In the above prior art, however, even if desired usable information is selected from a menu screen and even if a desired item is selected on a selected usable information screen, key-entry for specifying this desired usable information or item and key-entry for determining the selection are necessary and an operation costs much labor.

Further, if the desired usable information is selected on the menu screen, the information displayed by this selection indicates detailed contents of this selected usable information. If the contents of the usable information are desired to be known, the outline may be desired to be known instead of the details of the contents. Even in such a case, even if the user tries to know the contents of the desired usable information performing the operation of troublesome key-input as described above, the detailed contents are displayed and a certain degree of time for grasping their outline may also be required.

For example, if many schedules are stored in a memory unit as the usable information, their contents may be desired to be known roughly. Even in this case, such a troublesome key-entry operation as described above is performed every schedule and the outline of this schedule needs to be grasped from information about the detailed contents displayed every schedule. Accordingly, much labor and time are required to grasp the outlines of all the necessary schedules.

An object of the present invention is to provide a portable terminal unit such as a cellular phone which can solve this and other problems and grasp the contents of the desired usable information stored in the memory unit without costing much labor and by a simple method.

To attain the above object, the cellular phone of the present invention is provided with an input unit which enters information by key-entry, a memory unit which stores usable information of every kind, a display unit which displays various information, and an input processing unit which controls the memory unit and the display unit depending on information according to the key-input from the input unit. When the input unit performs the key-entry for selecting the desired usable information stored in the memory unit, the display unit displays a menu screen of the usable information which indicates a list consisting of a menu every usable information, and allows any one menu of the list to be instructed and selected with an instruction mark on this usable information menu screen. When no valid key-entry is made to the usable menu information even if a predetermined setting time elapses in a display state of this usable information menu screen, the display unit displays summary information which indicates the outline of the menu in accordance with the menu instructed and selected with the instruction mark on this usable information menu screen.

Further, preferably, the present invention allows summary information to be displayed in a dual window which is displayed on a usable information menu screen.

Further, preferably, the present invention allows a dual window to be displayed so that it cannot overlap with at least a menu instructed and selected with an instruction mark.

Further, preferably, the present invention, when an other menu is instructed and selected with an instruction mark in a display state of summary information, allows a screen to move to a usable information menu screen in a state in which other

Further, preferably, the present invention allows a state to move to a state in which detailed information about a menu instructed and selected with an instruction mark on a usable information menu screen in a display state of summary information by the predetermined key-entry of an input unit.

Further, To attain the above object, the cellular phone of the present invention is provided with an input unit which enters information by key-entry, a memory unit which stores usable information of every kind, a display unit which displays various information, and an input processing unit which controls the memory unit and the display unit depending on information according to the key-input from the input unit. When the input unit performs the key-entry for selecting the desired usable information stored in the memory unit, the display unit displays a menu screen of the usable information which indicates a list consisting of a menu every usable information, and allows any one menu of the list to be instructed and selected with an instruction mark on this usable information menu screen. When no valid key-entry is made to the usable menu information even if a predetermined setting time elapses in a display state of this usable information menu screen, the display unit displays summary information which indicates the outline of the menu in accordance with the menu instructed and selected with the instruction mark on this usable information menu screen.

### BRIEF DESCRIPTION OF THE DRAWINGS

FIG. 1 is a block diagram showing one embodiment of a cellular phone according to the present invention;

FIG. 2 is a top plan view showing one specific example of an input unit in FIG. 1;

FIG. 3 is a drawing showing one specific example of a screen displayed according to the embodiment shown in FIG. 1;

FIG. 4 is a drawing showing another specific example of a dual window display method on the screen displayed according to the embodiment shown in FIG. 1;

FIG. 5 is a flowchart showing one specific example of an operation in the embodiment shown in FIG. 1; and

FIG. 6 is a drawing showing a change of the screen displayed in the display unit of FIG. 1 according to the operation of FIG. 5.

### DESCRIPTION OF PREFERRED EMBODIMENTS

Embodiments of the present invention are described below with reference to the drawings.

FIG. 1 is a principal part block diagram showing one embodiment of a cellular phone according to the present invention. 1 is an input unit, 2 is an input processing unit, 3 is a memory unit, 3a is information about a telephone directory, 3b is information about a schedule, 3c is information about a task list, and 4 is a display unit.

In the same diagram, the input unit 1 performs a character input operation by mail and various key-entry operations, such a call operation and a screen operation. The information entered from the input unit 1 by such key-entry is supplied to the input processing unit 2 and processed. This input processing unit 2 controls and operates the memory unit 3 and the display unit 4 in accordance with the input information when the key-entry is made by the input unit 1.

This memory unit 3 stores usable information of every kind, such as the information 3a about the telephone directory, the information 3b about various schedules, and the information 3c about the task list which is various programs such as jobs. An owner (user) of this cellular phone enters these usable information from the input unit 1 as occasion demands. When such usable information are entered, the input processing unit 2 processes these usable information and creates detailed information described later and a menu screen for reading this detailed information, and then stores them in the corresponding place of the memory unit 3. Further, the user reads the detailed information stored in the memory unit 3 and can create summary information about the usable information by processing the detailed information. These detailed information and summary information are hierarchically linked with a menu on the menu screen and stored in the memory unit 3.

Further, the display unit 4 displays a menu screen, a passage, and an image through a call or by mail, and uses a liquid crystal screen as the display screen.

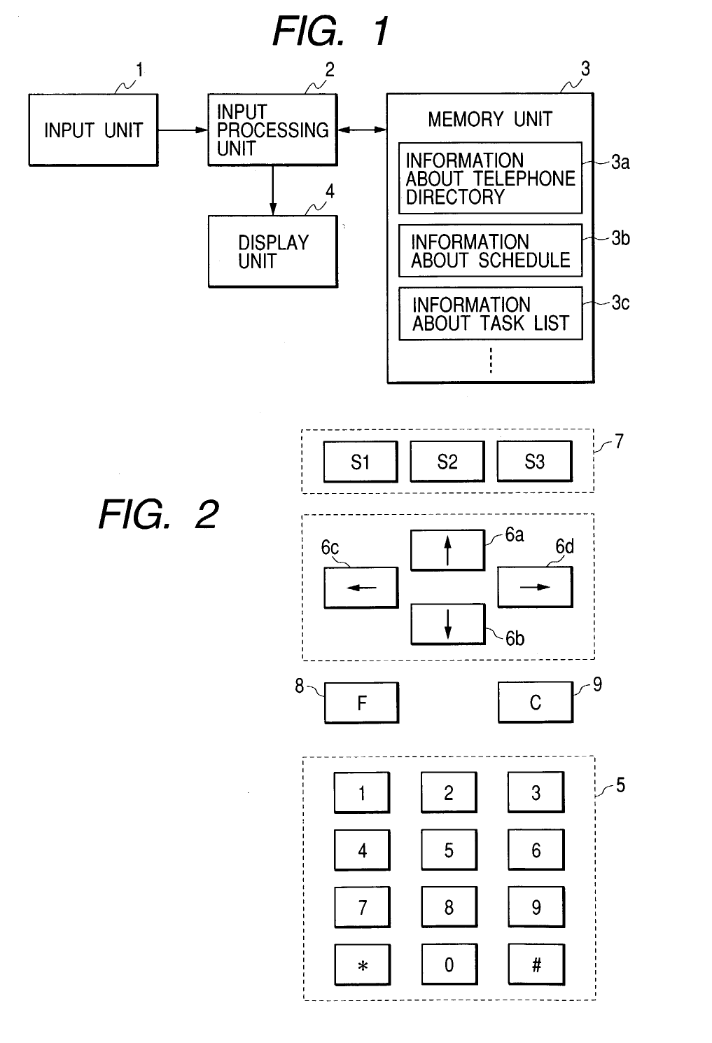

FIG. 2 is a top plan view showing one specific example of the input unit 1 in FIG. 1. 5 is a dial key, 6a to 6d are direction keys, 7 is a function key unit, 8 is a decision key, and 9 is a deletion key.

In the same view, the dial key 5 is composed of a character/numeric character key and a symbol key, and used for entry of a telephone number in case of a call, entry of a character or a numeric character, and a symbol in case of mail, and for entry for usable information. The direction keys 6a to 6d are used for vertically and horizontally moving an instruction mark, such as a focus, a cursor, or an arrow, displayed on the display screen of the display unit 4. Here, the direction key 6a, as shown by the arrow shown there, moves the instruction mark to the upward direction on the display screen. Similarly, the direction key 6b moves the instruction mark to the downward direction, the direction key 6c moves the instruction mark to the left direction, and the direction key 6d moves the instruction mark to the right direction respectively. The function key unit 7 is provided with function keys which assign functions in accordance with circumstances, that is, S1, S2, S3 and the functions assigned to these keys are displayed in the display screen of the display unit 4. These function keys S1, S2, S3 are arranged along the lower side of the display screen which is not shown in the display unit 4. Besides, the function key unit is assumed to be provided with the three function keys S1, S2, S3 and the number of function keys is not limited to the three keys. The decision key 8 has a function of determining an item selected with the instruction mark on the display screen of the display unit 4 and an input character for character entry. The deletion key 9 is used to delete a character entered by the operation of the dial key 5.

Next, a selection display of the usable information stored in the memory unit 3 according to this embodiment is described.

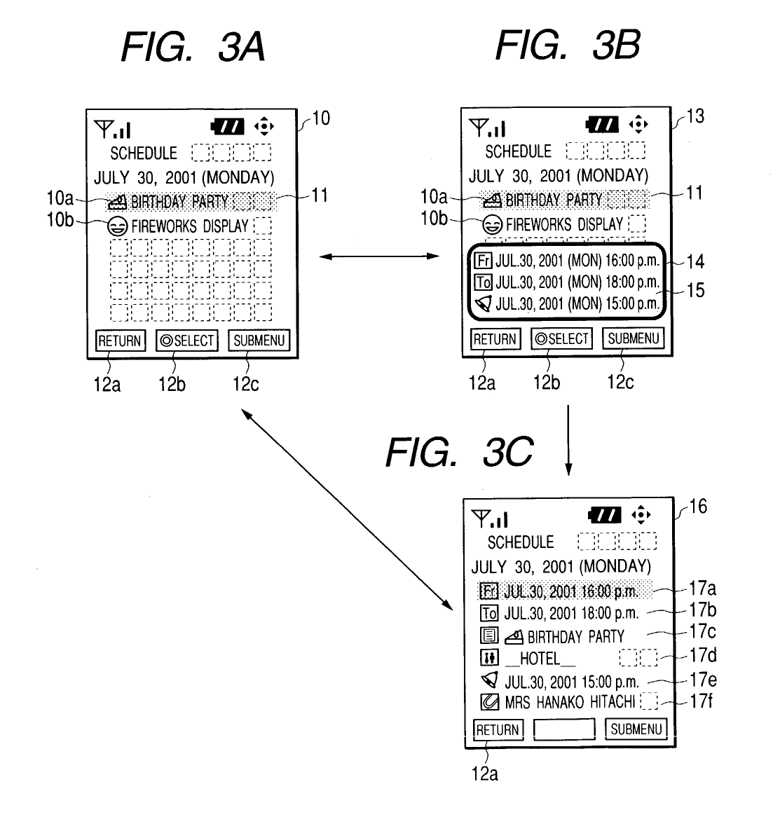

Now, the selection display of the information 3b about the schedule as the usable information stored in the memory unit 3 is described as an example. In this example, if, at first, a menu ‘schedule’ is selected on a high-level menu screen not shown by the predetermined key operation of the input unit 1, the information 3b about the predetermined schedule is read from the memory unit 3. When the input processing unit 2 controls the display unit 4 in accordance with this information, such a schedule menu screen 10 as shown in FIG. 3A which displays a menu list every schedule is displayed on the display screen. Here, each schedule on Jul. 30, 2001 is assumed to be shown. A birthday party and a fireworks display are projected and a ‘Birthday Party’ 10a and a ‘Fireworks Display’ 10b are displayed as schedule menus.

Further, a focus 11 shown in a half-tone dot meshing form (shaded form) for selecting one of these menus is also displayed at the same time. This focus is always adjusted to a single menu and the menu enters a selected state. In an initial state in which the schedule menu screen 10 was displayed, the focus 11 is adjusted to the menu located in the highest level (the menu ‘Birthday Party’ 10a in this case) and this menu 10a enters a selected state. This focus 11 moves on the schedule menu screen 10 upward by one step and changes a menu to be selected sequentially every time the direction key 6a (FIG. 2) having an upward arrow is operated. Similarly, every time the direction key 6b (FIG. 2) having a downward arrow is operated, the focus 11 moves on the schedule menu screen 10 downward by one step and changes the menu to be selected sequentially. Besides, even if the other direction keys 6c, 6d are operated, the focus 11 does not move, and, therefore, they are not valid keys for the schedule menu screen 10.

Moreover, function display units 12a, 12b, 12c are displayed at the lower part of the schedule menu screen 10 in the cross direction, that is, so that they can be opposed to the function keys S1, S2, S3 (FIG. 2). Here, the function display unit 12a indicates a function ‘Return’ of the function key S1, the function display unit 12b indicates a function ‘Select’ of the function key S2, and the function display unit 12c indicates a function ‘Submenu’ of the function key S3 respectively. Accordingly, in this case, the function key S1 functions as the ‘Return’ key, the function key S2 functions as the ‘Select’ key, and the function key S3 functions as the ‘Submenu’ key.

This schedule menu screen 10 can move to either a schedule outline screen 13 as shown in FIG. 3B or a detailed schedule screen 16 as shown in FIG. 3C. Further, this schedule outline screen 13 can return to the original schedule menu screen 10 shown in FIG. 3A and can move to the detailed schedule screen 16. Moreover, the detailed schedule screen 16 can also return to the original schedule menu screen 10.

That is, the menu ‘schedule’ is selected on the high-level menu screen of usable information not shown and the schedule menu screen 10 shown in FIG. 3A is displayed. At this occasion, if no valid key-entry is made to this schedule menu screen 10 (that is, the schedule menu screen 10 is not altered) while a predetermined setting time T (for example, approximately several seconds) elapse, the screen automatically moves to the schedule outline screen 13 shown in FIG. 3B. A dual window 14 is then displayed on this schedule outline screen 13. Further, the summary information which indicates the outline of the menu (menu ‘Birthday Party’ 10a in this case) specified with the focus 11 is read from the information 3b about the schedule of the memory unit 3 (FIG. 1) and displayed in this dual window 14 as summary information 15.

This dual window 14 is displayed so that it cannot overlap with the menu ‘Birthday Party’ 10a in which the focus 11 is specified repetitively, and cannot overlap with the function display units 12a, 12b, 12c. Accordingly, the user can simply know which menu the summary information 15 displayed in the dual window 14 is.

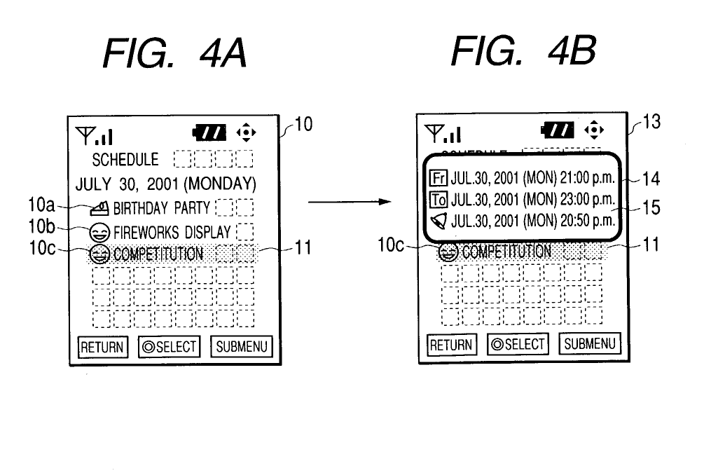

Accordingly, for example, as shown in FIG. 4A, the schedule menu screen 10 has the menus ‘Birthday Party’ 10a and ‘Fireworks Display’ 10b, and a menu ‘Having Party with’ 10c. If the above setting time T elapses with the menu ‘Having Party with’ 10C displayed at the lowermost side specified with the focus 11 as is, the dual window 14 which shows the summary information 15 of this menu 10c at the upper side than the display position of the menu ‘Having Party with’ 10c specified with the focus 11 is displayed. Consequently, the menu ‘Having Party with’ 10c specified with the focus 11 and the dual window 14 which shows the summary information are displayed at the same time.

Returning to FIG. 3, when the function key S1 (FIG. 2) to which the ‘Return’ function displayed by the function display unit 12a is assigned is operated in the display state of the schedule outline screen 13 shown in FIG. 3B, the display state of the original schedule outline screen 13 shown in FIG. 3B is restored. When the function key S2 (FIG. 2) to which the ‘Select’ function displayed on the function display unit 12b is assigned is operated, however the state moves to the display state of the detailed schedule screen 16 as shown in FIG. 3C. Further, even if the function key S2 to which the ‘Select’ function displayed by the function display unit 12b is assigned is operated in the display state of the schedule menu screen 10 shown in FIG. 3A (that is, before the screen is changed to the schedule outline screen 13 shown in FIG. 3B, the state will move to the display state of the detailed schedule screen 16 as shown in FIG. 3C in the same manner.

The detailed information about the menu (menu ‘Birthday Party 10a in this case) selected with the focus 11 is read from the information 3b about the schedule of the memory unit 3 (FIG. 1) and displayed on this detailed schedule screen 16. As the detailed information in case that the schedule is a birthday party, for example, there are a starting time 17a, an ending time 17b, an engagement (birthday party) 17c, a place 17d, an alarm setting time 17e, and a memory 17f.

Besides, the focus 11 is not displayed on the detailed schedule screen 16. Accordingly, the function display unit 12b does not display a function (in this case, no function is assigned to the function key S2 (FIG. 2)) or displays other necessary functions which are not valid for the detailed schedule screen 16. FIG. 3C indicates that no function is displayed in the function display unit 12b.

Further, the function ‘Submenu’ of the function key S3 (FIG. 2) displayed in the function display unit 12c, for example, relates to the deletion or addition of usable information, or the addition or deletion of detailed information. A summary information creation item is provided as one item of this function ‘Submenu’. When the function key S3 is operated in the display state of the detailed schedule screen 16 and the summary information creation item is selected from the submenu, the summary information can be created by choosing the detailed information displayed on the detailed schedule screen 16. The summary information created in this manner is stored in the corresponding place of the memory unit 3 by the predetermined key operation. At the same time, the display state of the detailed schedule screen 16 is restored.

Moreover, as the summary information 15 displayed in the dual window 14 on the schedule outline screen 13 shown in FIG. 3B, a part of the detailed information displayed on the detailed schedule screen 16, that is, such information from which the outline of the menu contents selected with the focus 11 is known at a glance, for example, in case of the menu ‘Birthday Party’ 10a, the starting time 17a, the ending time 17b, and the alarm setting time 17e in FIG. 3C are assumed to be the summary information 15.

When the function key S1 (FIG. 2) to which the ‘Return’ function displayed by the function display unit 12a is assigned is operated on the detailed schedule screen 16, the display state of the original schedule menu screen 10 shown in FIG. 3A is restored. When the function key S1 having the ‘Return’ function is operated on the schedule outline screen 13 or the detailed schedule screen 16, the schedule menu screen 10 returns. This returned schedule menu screen 10 also moves to the schedule outline screen 13 shown in FIG. 3B for the menu specified with the focus 11 at that time when the above setting time T elapses without changing the display state.

Further, before the above setting time T elapses after the schedule menu screen 10 is displayed, the direction key 6b (FIG. 2) is operated and another menu is selected and specified. Even if no valid key-entry is made subsequently until this setting time T elapses, the display moves to the display of the schedule outline screen 13 for this specified menu. That is, if the display state of the schedule menu screen 10 continues only for the above setting time T as is, the screen automatically moves to the schedule outline screen 13.

Besides, when the focus 11 is moved downward and the next menu ‘Fireworks Display’ is instructed and selected by operating the direction key 6b (FIG. 2) on the schedule outline screen 13 as shown in FIG. 3B, the state moves to the display state of the schedule menu screen 10 as shown in FIG. 3A of the state in which the menu ‘Fireworks Display’ is selected.

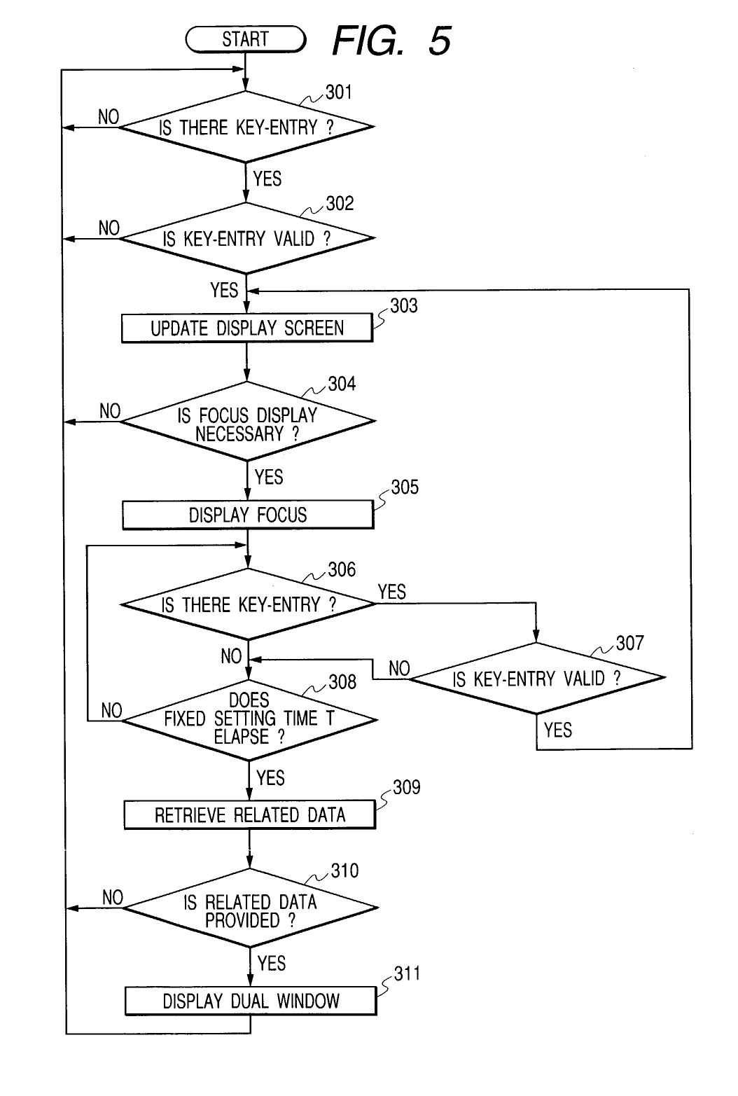

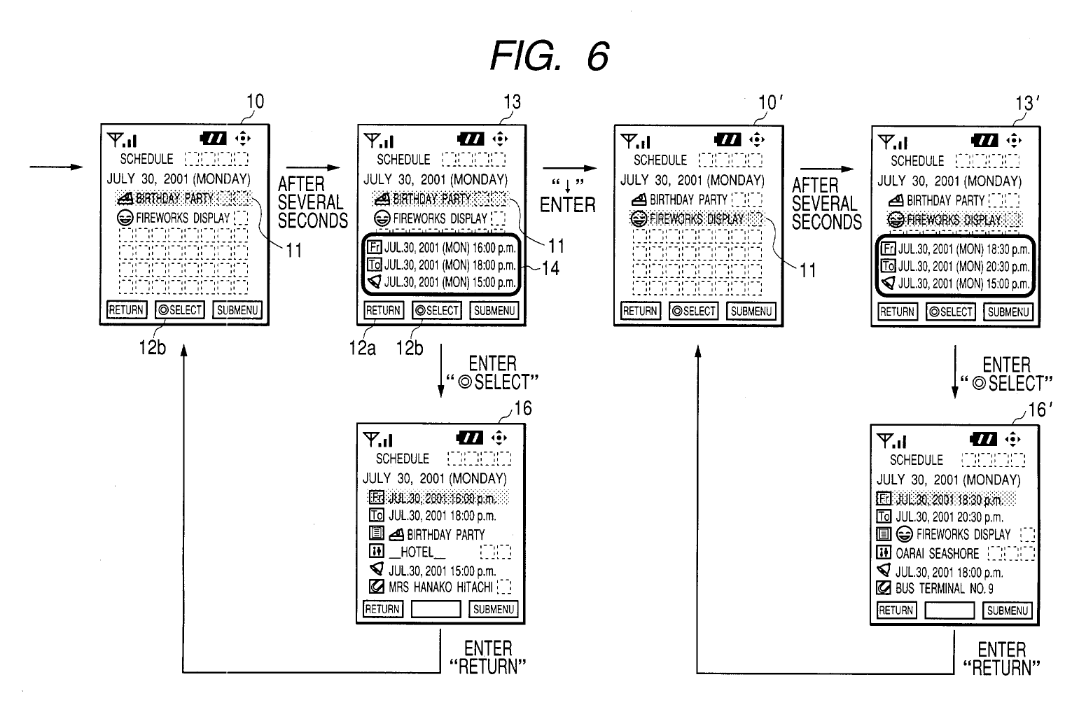

Next, one specific example of the operation of this embodiment is described using the menu ‘Schedule’ as an example. FIG. 5 is a flowchart showing such operation and FIG. 6 is a drawing showing a change of the schedule screen displayed on the display screen of the display unit 4 (FIG. 1) in accordance with this operation.

In FIGS. 5 and 6, a state in which a high-level menu screen not shown consisting of each usable information menu list is displayed is assumed to occur and such a display state is assumed to be a started state of this operation. This high-level menu screen is used to select various information stored in the memory unit 3 (FIG. 1). Until key-entry is made (step 301), and until the input information is valid information (for example, information for menu selection) for the high-level menu screen even if the key-entry is made (step 302), processing enters a wait state and the display of the high-level menu screen continues as is.

When the menu ‘Schedule’ is displayed on this high-level menu screen by the predetermined key-entry (steps 301, 302), the display screen is updated and such schedule menu screen 10 as described in FIG. 3A is displayed (step 303). Subsequently, whether or not a focus display is necessary for this newly displayed screen is judged (step 304), and the next key-entry is awaited if unnecessary (step 301). Because the schedule menu screen 10 requires the focus display, the focus 11 is displayed there (step 305).

Along with this, while a clocking operation is starting and the presence of the key-entry is being judged (step 306), a lapse of the above setting time T (for example, approximately several seconds) is awaited (step 308). If valid key-entry is provided on the schedule menu screen 10 (steps 306, 307) before this setting time T elapses, the display screen is updated (step 303) and processing goes to the step 304. For example, if the function key S2 (FIG. 2) to which the function ‘Select’ displayed by the function display unit 12b is assigned is operated in the display state of the schedule menu screen 10, this indicates that the valid key-entry is provided on the schedule menu screen 10 (steps 306, 307) and, as shown in FIG. 3, the detailed schedule screen 16 is displayed (step 303). Subsequently, because the focus display is unnecessary (step 304) on this detailed schedule screen 16, processing returns to the step 301 and the next valid key-entry is awaited (steps 301, 302).

When the display of the schedule menu screen 10 continues as is and the setting time T elapses (step 308), the related data of the menu (menu ‘Birthday Party’ in this case), that is, the summary information of the menu ‘Birthday Party’ specified with the focus 11 on the schedule menu screen 10 is retrieved from the information 3b about the schedule of the memory unit 3 (FIG. 1) (step 309). Unless this information is provided, processing returns to the step 301 and enters a wait state without changing the schedule menu screen 10. When the related data (summary information) is retrieved (step 310), however, as described in FIG. 3, the schedule outline screen 13 on which the dual window 14 including the summary information 15 is displayed is displayed on the schedule menu screen 10 (step 311). Subsequently, in the display state of this schedule outline screen 13, the valid key-entry for this state is awaited (steps 301, 302).

Accordingly, when the function key S1 (FIG. 2) to which the function ‘Return’ displayed in the function display unit 12a is assigned is operated (steps 301, 302), the display screen is updated and the original schedule menu screen 10 is displayed (step 303). In this case, because the focus 11 is required (step 304), the focus is displayed (step 305) and processing moves to the above operation from the step 306.

Further, when the function key S2 (FIG. 2) to which the function ‘Select’ displayed by the function display unit 12b is assigned is operated (steps 301, 302) in the display state of the schedule outline screen 13, the display screen is updated and the detailed schedule screen 16 is displayed (step 303). In this case, because no focus is necessary (step 304), the next valid key-entry is awaited in the display state of this detailed schedule screen 16 (steps 301, 302).

Moreover, when a direction key, that is, the direction key 6b (FIG. 2) which shows an arrow downward is operated in the display state of the schedule outline screen 13 (steps 301, 302), the focus 11 moves downward one step and is adjusted to the next menu ‘Fireworks Display’. Accordingly, the display screen is updated and a schedule menu screen 10′ which selected this menu ‘Fireworks Display’ is displayed (step 303).

This schedule menu screen 10′ is also identical to the previous schedule menu screen 10. The focus 11 is displayed (steps 304, 305) and the above operation is performed from the step 306. A schedule outline screen 13′ and a detailed schedule screen 16′ can be displayed.

When the schedule menu screen 10 is displayed in this manner according to this embodiment, even if no key-entry is made or if no key-entry which specified a desired menu is made as is, the screen automatically moves to the schedule outline screen 13 and the outline of the menu can be known without operation.

Besides, the above embodiment is described based on the information 3b about the schedule. Needless to say, however, other usable information stored in the memory unit 3, such as the information 3a about the telephone directory and the information 3c about the task list, are identical. Accordingly, in one embodiment of the present invention, an attempt is also made to be able to know the outline of the menu in accordance with the menu without operation.

Further, because it also seems to be troublesome that summary information is displayed automatically, a mode which will not display the summary information automatically may also be able to be set. Moreover, if the mode which will not display the summary information is set, in the other embodiment of the present invention, the summary information can also be displayed by pressing the predetermined button.

Further, in the above embodiment, the focus was used as an instruction mark, but, needless to say, another instruction mark, such as a cursor or an arrow may also be used.

Moreover, the above setting time T was set to approximately several seconds, but it is not limited to this time and can suitably be set for an optional necessary time.

Further, in the above embodiment, a cellular phone is taken as an example, but the example will not be limited to this cellular phone. A portable terminal unit such as a PDA (personal digital assistant) is also an ideal embodiment of the present invention.

As described above, according to the present invention, the outline of the contents of usable information can be displayed on the display screen by simplifying operation and the user can grasp the contents of the usable information by saving time and removing excessive information.

What is claimed is:

1. A cellular phone, comprising:
an input unit for inputting information by key-entry;
a memory unit for storing usable information of every kind;
a display unit for displaying various information; and
an input processing unit for controlling said memory unit and said display unit depending on said information according to the key-entry from said input unit,
wherein said display unit displays a menu screen of the usable information which indicates a list consisting of a menu every usable information, and allows any one menu of said list to be instructed and selected with an instruction mark on said usable information menu screen when said input unit performs the key-entry for selecting a piece of usable information from the usable information stored in said memory unit, and
wherein said display unit displays summary information which indicates the outline of the menu in accordance with the menu instructed and selected with said instruction mark on said usable information menu screen when no valid key-entry is made to said usable information menu screen even if a predetermined setting time elapses in a display state of said usable information menu screen.

2. The cellular phone according to claim 1, wherein said summary information is displayed in a dual window which is displayed on said usable information menu screen.

3. The cellular phone according to claim 2, wherein said dual window is displayed so that it is not overlapped with said menu instructed and selected with at least said instruction mark.

4. The cellular phone according to claim 1, wherein if another menu is instructed and selected with said instruction mark in the display state of said summary information, the screen is changed to said usable information menu screen in the state in which said another menu is instructed and selected.

5. The cellular phone according to claim 1, wherein the state moves to the state in which detailed information about said menu instructed and selected with said instruction mark is displayed on said usable information menu screen by the predetermined key-entry of said input unit in the display state of said summary information.

6. A portable terminal unit, comprising:
an input unit for inputting information by key-entry;
a memory unit for storing usable information of every kind;
a display unit for displaying various information; and
an input processing unit for controlling said memory unit and said display unit depending on said information according to the key-entry from said input unit,
wherein said display unit displays a menu screen of the usable information which indicates a list consisting of a menu every usable information, and allows any one menu of said list to be instructed and selected with an instruction mark on said usable information menu screen when said input unit performs the key-entry for selecting a piece of usable information from the usable information stored in said memory unit, and
wherein said display unit displays summary information which indicates the outline of the menu in accordance with the menu instructed and selected with said instruction mark on said usable information menu screen when no valid key-entry is made to said usable information menu screen even if a predetermined setting time elapses in a display state of said usable information menu screen.

7. The portable terminal unit according to claim 6, wherein said menu is a schedule.

8. The portable terminal unit according to claim 6, further comprising:
a summary information display setting unit which can set said summary information so that it cannot be displayed on said display unit even when no valid key-entry is made on said usable information menu screen even if the predetermined setting time elapses in the display state of said usable information menu screen.

9. The portable terminal unit according to claim 8, wherein even if said summary information display unit sets said summary information so that it cannot be displayed on said display unit, said summary information is displayed on said display unit by performing a predetermined operation.
